(19) United States
(12) Patent Application Publication
(10) Pub. No.: US 2012/0091911 A1
(43) Pub. Date: Apr. 19, 2012

(54) ARRANGEMENT AND METHOD FOR IMPROVING THE POWER FACTOR OF A LIGHTING

(76) Inventor: SHENG - FENG WANG, Taipei (TW)

(21) Appl. No.: 12/905,109

(22) Filed: Oct. 15, 2010

(51) Int. Cl. H05B 41/36

(52) U.S. Cl. 315/291

(57) ABSTRACT

An arrangement and method for improving the power factor of a lighting includes a compensating device having a first pin electrically connected to a power source and a second pin electrically connected to a third joining. The power source is electrically connected to a first joining, and a fluorescent tube is electrically connected to the third joining and the first joining. The compensating device and the power source will become an open loop while the fluorescent tube is broken or removed so as to save energy.

### FIELD OF THE INVENTION

The present invention relates to method for saving energy and power factor improvement, and particular to an arrangement and a method for improving the power factor of a lighting and saving energy by forming an open loop between a compensating device and a power source while a fluorescent tube is broken or removed.

### DESCRIPTION OF THE PRIOR ART

Fluorescent tubes are used as illumination for a long time, while the power consumption of the fluorescent tube is not well concerned until the energy saving and carbon reduction awakening are promoted recently.

Prior method of lower the power consumption of the fluorescent tubes is through electrically connected a compensating device to the power source connected to the fluorescent tubes. However, the loop of the power source and the compensating device will still consume energy after a breakage or removal of the fluorescent tube.

Therefore, the prior arrangement and method could lower the power consumption of the fluorescent tube and also might cause extra power consumption while the fluorescent tube is broken or removed. The unexpected effect needs to be corrected.

### SUMMARY OF THE PRESENT INVENTION

Accordingly, the primary object of the present invention is to provide an arrangement and method for saving energy and improving the power factor of a lighting while a fluorescent tube of the lighting is broken or removed.

To achieve above object, the present invention provide an arrangement by electrically connecting an output end of an inductive ballast to a second joining, and electrically connecting a starter to a third joining and a fourth joining. A second pin of the compensating device is electrically connected to the third joining, a first pin of the compensating device is electrically connected to an input end of the inductive ballast. A power source is separately electrically connected to the first joining and the first pin of the compensating device.

Another object of the present invention is to provide a method for improving the power factor of a lighting. The power source is electrically connected to the first joining and the first pin of the compensating device, and the second pin of the compensating device is electrically connected to the third joining. While the fluorescent tube electrically connected to the first joining and the third joining is broken and removed, the compensating device and the power source will become an open loop.

Therefore, by forming an open loop, the compensating device will no longer consume energy while the fluorescent tube is broken or removed.

### BRIEF DESCRIPTION OF THE DRAWINGS

FIG. 1 is a schematic view showing the first embodiment of an arrangement for improving the power factor of a lighting according to the present invention. FIG. 2 is a schematic view showing the second embodiment of an arrangement for improving the power factor of a lighting according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

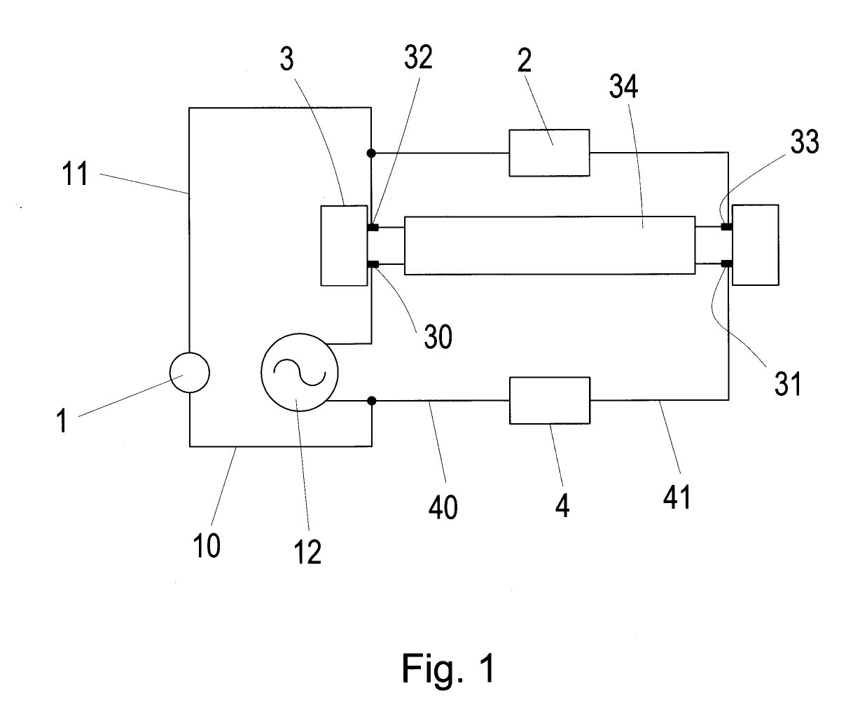

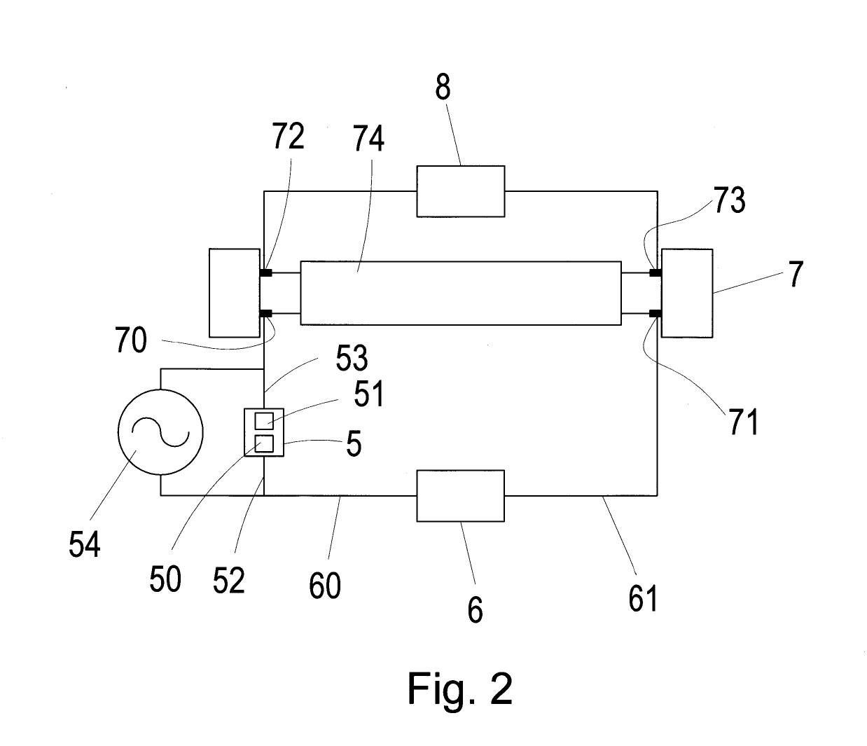

Referring to FIG. 1, the first embodiment of an arrangement for improving the power factor of a lighting is illustrated. The embodiment includes a compensating device 1, starter 2, lamp holder 3, and an inductive ballast 4.

The compensating device 1 has a first pin 10 and a second pin 11. The first pin 10 is electrically connected to a power source 12. The compensating device 1 may be a capacitor for selectively compensating the power source 12 and improving the power factor of the lighting.

The lamp holder 3 has a first joining 30, second joining 31, third joining 32, and a fourth joining 33. A fluorescent tube 34 is received to the lamp holder 3. The fluorescent tube 34 is electrically connected to the joinings 30 to 33. The first joining 30 is electrically connected to the power source 12, and the third joining 32 is electrically connected to the second pin 11 of the compensating device 1.

The starter 2 is electrically connected to the third joining 32 and the fourth joining 33.

The inductive ballast 4 has an input end 40 and an output end 41. The output end 41 is electrically connected to the second joining 31, and the input end 40 is electrically connected to the first pin 10.

The present invention is about a method for improving the power factor of a lighting as shown in FIG. 1. The power source 12 is connected to the first joining 30. The first pin 10 is electrically connected to the power source 12. The third joining 32 is electrically connected to the second pin 11. The first joining 30 and the third joining 32 are electrically connected to the fluorescent tube 34 so that the compensating device 1, power source 12, lamp holder 3, and the fluorescent tube 34 form a close loop. While the fluorescent tube 34 is broken or removed, above loop becomes an open loop so that the compensating device 1 will no longer consume power from the power source 12.

Referring to FIG. 2, a second embodiment of an arrangement for improving the power factor of a lighting according to the present invention is illustrated. The embodiment has a safety breaker 5, inductive ballast 6, lamp holder 7, and a starter 8.

The lamp holder 7 has a first joining 70, second joining 71, third joining 72, and a fourth joining 73. A fluorescent tube 74 is fixed to the lamp holder 7 and electrically connected to the first to the fourth joinings 70, 71, 72, 73, and the first joining 70 is electrically connected to power source 54.

The starter 8 is electrically connected to the third joining 72 and the fourth joining 73.

The safety breaker 5 may be formed by a capacitor 50 and a protection device 51. The safety breaker 5 has at least one input end 52 and at least one output end 53. The output end 53 is electrically connected to the first joining 70, and the input end 52 is electrically connected to the power source 54 so that the capacitor 50 will selectively compensate the power source 54 and promote the power factor of the lighting.

The inductive ballast 6 has an input end 60 and an output end 61. The input end 60 is electrically connected to the input end 52 of the safety breaker 5, and the output end 61 is electrically connected to the second joining 71.

Referring to FIG. 2, the second embodiment of a method for improving the power factor of a lighting is illustrated. The input end 52 of the safety breaker 5 is electrically connected to the power source 54, and the power source 54 is further electrically connected to the first joining 70. The output end 53 of the safety breaker 5 is electrically connected to the first joining 70.

The fluorescent tube 74 is electrically connected to the first joining 70 so that the power source 54, safety breaker 5, lamp holder 7, and the fluorescent tube 74 form a close loop. While the fluorescent tube 74 is broken or removed, the protection device 51 will automatically open the loop between the safety breaker 5 and the power source 54. Therefore, the capacitor 50 is no longer connected to the power source 54 and is unable to consume power from the power source 54.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

1. An arrangement for improving the power factor of a lighting comprising:
a first joining, a second joining, a third joining, and a fourth joining;
an inductive ballast having an input end and an output end; the output end being electrically connected to the second joining;
a starter electrically connected the third joining and the fourth joining; and
a compensating device having a first pin and a second pin; the second pin being electrically connected to the third joining, and the first pin being electrically connected to the input end of the inductive ballast;
wherein the first joining and the first pin of the compensating device are respectively electrically connected to a power source.

2. The arrangement for improving the power factor of a lighting as claimed in claim 1, wherein the first to the fourth joinings are arranged to a lamp holder which is receiving and powering a fluorescent tube; the compensating device may be a capacitor.

3. A method for improving the power factor of a lighting comprising:
a power source electrically connected to a first joining;
a compensating device having a first pin and a second pin; the first pin being electrically connected to the power source, and the second pin being electrically connected to a third joining;
a fluorescent tube being electrically connected to the first joining and the third joining;
wherein the compensating device and the power source will become an open loop while the fluorescent tube is broken or removed.

4. The method for improving the power factor of a lighting as claimed in claim 3, wherein the first and the third joining are arranged to a lamp holder which is receiving and powering the fluorescent tube.

5. An arrangement for improving the power factor of a lighting comprising:
a first joining, a second joining, a third joining, and a fourth joining;
a safety breaker having at least one input end and at least one output end;
the output end being electrically connected to the first joining;
an inductive ballast having an input end and an output end; the input end being electrically connected to the input end of the safety breaker, and the output end being electrically connected to the second joining; and
a starter being electrically connected to the third joining and the fourth joining;
wherein a power source is electrically connected to the first joining and the input end of the safety breaker respectively; the safety breaker will selectively compensate the power source and improve the power factor of the lighting.

6. The arrangement for improving the power factor of a lighting as claimed in claim 5, wherein the first to the fourth joinings are arranged to a lamp holder which is receiving and powering a fluorescent tube.

7. The arrangement for improving the power factor of a lighting as claimed in claim 5, wherein the safety breaker may be formed by a capacitor and a protection device.

8-10. (canceled)
